(19) United States
(12) Patent Application Publication
(10) Pub. No.: US 2011/0020565 A1
(43) Pub. Date: Jan. 27, 2011

(54) DRYING METHOD AND DEVICE

(76) Inventors: Kenichi Yasuda, Kanagawa (JP); Kazuhiro Oki, Kanagawa (JP)

Correspondence Address: BIRCH STEWART KOLASCH & BIRCH, PO BOX 747, FALLS CHURCH, VA, 22040-0747, US

(21) Appl. No.: 12/935,531

(22) PCT Filed: Mar. 13, 2009
(86) PCT No.: PCT/JP2009/054920

§ 371 Date: Sep. 29, 2010

(30) Foreign Application Priority Data
Mar. 31, 2008 (JP) 2008-090488

(51) Int. Cl. B05D 3/06; F26B 9/00; B05D 5/06

(52) U.S. Cl. 427/557; 34/618

(57) ABSTRACT

According to one aspect of the present invention, a drying device which dries a coating film formed on a substrate with hot air, including an infrared radiator which heats the coating film at a temperature equal to or lower than the temperature of the hot air is provided. The hot air drying device includes the infrared radiator which heats the coating film. Accordingly, the temperature of the coating film in the initial drying stage can be quickly raised by the infrared radiator in comparison with a case in which the coating film is dried only with the hot air. Also, since the infrared radiator heats the coating film at a temperature equal to or lower than the hot air temperature, there is no risk of reducing the quality of the coating film by overheating the coating film. Accordingly, energy consumption can be reduced, and the drying speed can be increased. Any member may be used as the infrared radiator as long as the member can radiate infrared rays to heat the coating film at a low temperature equal to or lower than the hot air temperature. For example, a panel infrared heater may be employed.

### TECHNICAL FIELD

The present invention relates to a drying method and device, and more particularly, to a technique for drying a coating film obtained by coating a continuously travelling flexible film with various coating solutions.

### BACKGROUND ART

A drying method of blowing drying air having a predetermined temperature onto a coating film surface has been widely employed as a method for drying a coating film. However, the coating film surface may become uneven with concavities and convexities when blown due to the pressure of the air blown thereto.

To solve the problem, for example, Patent Document 1 proposes to heat a coating film for 10 seconds or less after coating by an infrared heater or microwaves while minimizing the wind speed of drying air that strikes the coating film, to thereby suppress unevenness occurring when the coating film is blown with the drying air. The drying speed can be thereby increased.

Patent Document 2 proposes to evaporate and dry a solvent gas contained in a coating film by a panel electric infrared heater or the like installed within a drying oven. Also, the temperature of the coating film in the initial drying stage is controlled to rise gradually from a low temperature, to thereby suppress coating unevenness occurring when the solvent in the coating film appears as bubbles.

Patent Document 3 proposes to maintain heating efficiency by blocking a particular wavelength that affects a photosensitive layer of a photosensitive planographic printing plate when the photosensitive layer is dried by an infrared heater.

Patent Document 1: Japanese Patent Application Laid-Open No. 2000-329463

Patent Document 2: Japanese Patent Application Laid-Open No. 11-254642

Patent Document 3: Japanese Patent Application Laid-Open No. 2005-215024

### DISCLOSURE OF THE INVENTION

### Problems to be Solved by the Invention

In Patent Documents 1 to 3 described above, however, since the coating film in the initial drying stage is mainly dried by the infrared heater, the heating temperature of the infrared heater needs to be raised to a sufficient level relative to the temperature of the coating film. Thus, there is a problem that the energy efficiency is very low.

That is, in Patent Document 1, the coating film is dried by raising the temperature of the coating film from a low level immediately after coating. In Patent Document 2, the heating temperature of the infrared heater needs to be set to about 500° C. In both the cases, the heating temperature of the infrared heater needs to be raised to a sufficient level.

Also, the quality of the coating film may be reduced when the coating film is exposed to a high temperature by the infrared heater as in Patent Document 2. Thus, the temperature of the coating film in the initial drying stage needs to be low, and there occurs a problem that temperature control is complicated.

The present invention has been made in view of the aforementioned circumstances, and it is an object of the present invention to provide a drying method and device which reduces energy consumption required for drying, and substantially increases a drying speed without reduction in quality.

### Means for Solving the Problems

In order to achieve the above object, a first aspect of the present invention provides a drying device which dries a coating film formed on a substrate with hot air, including an infrared radiator which heats the coating film at a temperature equal to or lower than a temperature of the hot air.

With the first aspect, the hot air drying device includes the infrared radiator which heats the coating film. Accordingly, the temperature of the coating film in the initial drying stage can be quickly raised by the infrared radiator in comparison with a case in which the coating film is dried only with the hot air. Also, since the infrared radiator heats the coating film at a temperature equal to or lower than the temperature of the hot air, there is no risk of reducing the quality of the coating film by overheating the coating film. Accordingly, energy consumption can be reduced, and the drying speed can be increased. Any member may be used as the infrared radiator as long as the member can radiate infrared rays to heat the coating film at a low temperature equal to or lower than the temperature of the hot air. For example, a panel infrared heater may be employed.

According to a second aspect of the present invention based on the first aspect, the infrared radiator is a plate member or a pipe member which is disposed facing the substrate at a predetermined distance from the substrate.

With the second aspect, the plate member or the pipe member is disposed facing the substrate at a predetermined distance from the substrate, and thus, can emit radiation heat almost uniformly over the entire substrate surface. Accordingly, the drying speed can be increased uniformly over the entire coating film.

According to a third aspect of the present invention based on the second aspect, a distance between the infrared radiator and the substrate is 100 mm or less.

With the third aspect, since the distance between the infrared radiator and the substrate is 100 mm or less, the radiation heat of the infrared radiator can be effectively used.

According to a fourth aspect of the present invention based on any one of the first to third aspects, a surface of the infrared radiator is coated with ceramics or black color.

With the fourth aspect, since the surface of the infrared radiator is coated with ceramics or black color, the efficiency of infrared radiation can be improved.

According to a fifth aspect of the present invention based on any one of the first to fourth aspects, the infrared radiator is made of metal.

With the fifth aspect, since the infrared radiator is made of metal having a high thermal conductivity, the heat of the hot air within the device can be effectively absorbed. Thus, energy required for a heat source of the infrared radiator can be reduced.

According to a sixth aspect of the present invention based on any one of the first to fifth aspects, the infrared radiator is heated by one or more of hot air, steam, superheated steam, and hot water generated in the hot air drying process or another process.

With the sixth aspect, since the exhaust heat in the hot air drying process or another process is used as the heat source of the infrared radiator, energy required for drying can be reduced.

In order to achieve the above object, a seventh aspect of the present invention provides a method for producing an optical film, including the steps of coating a travelling long substrate with a coating solution for optical applications, and drying the coating solution with hot air, wherein the coating solution is dried by using a device according to any one of the first to sixth aspects.

With the seventh aspects, a coating film for optical applications can be quickly dried at a low temperature equal to or lower than the temperature of the hot air.

According to an eighth aspect of the present invention based on the seventh aspect, a heating temperature of the infrared radiator is 80 to 150° C.

When the heating temperature is too low, the heating effect may be reduced. When the heating temperature is too high, the coating film or the substrate may be reduced in quality. With the eighth aspect, especially when the coating solution for optical applications is used, the drying and heating speed can be increased without reducing the quality of the coating film by setting the heating temperature of the infrared radiator within the above range.

According to a ninth aspect of the present invention based on the seventh or eighth aspect, the coating solution contains a liquid crystalline compound.

With the ninth aspect, when an optically anisotropic layer containing the liquid crystalline compound is initially dried, the layer can be quickly dried at a low temperature. Thus, the layer can be effectively dried without any troubles such as alignment defects and drying unevenness.

### ADVANTAGES OF THE INVENTION

With the present invention, the energy consumption required for drying can be reduced, and the drying speed can be increased without reducing the quality.

### BRIEF DESCRIPTION OF THE DRAWINGS

FIG. 1 is an explanatory view for explaining an example of a coating and drying line according to a present embodiment;

FIG. 2 is an explanatory view for explaining an example of a drying device according to the present embodiment;

FIG. 3 is a schematic view illustrating another embodiment;

FIG. 4 is a schematic view illustrating an example of an apparatus for producing an optical compensation sheet according to the present embodiment;

FIG. 5 is a table illustrating results according to a present example; and

FIG. 6 is a table illustrating results according to the present example.

### DESCRIPTION OF SYMBOLS

10 . . . . Coating and drying line
12 . . . . Flexible film
16 . . . . Coating means
18 . . . . Drying device
20 . . . . Infrared radiation plate
22 . . . . Air feed duct
24 . . . . Air discharge duct
26 . . . . Pipe-like infrared radiator
28 . . . . Thermometer
30 . . . . Control means
32 . . . . Valve
42 . . . . Transparent film
58 . . . . Drying process
60 . . . . Liquid crystal layer forming process

### BEST MODE FOR CARRYING OUT THE INVENTION

In the following, a preferred embodiment of a drying device according to the present invention will be described by reference to the accompanying drawings.

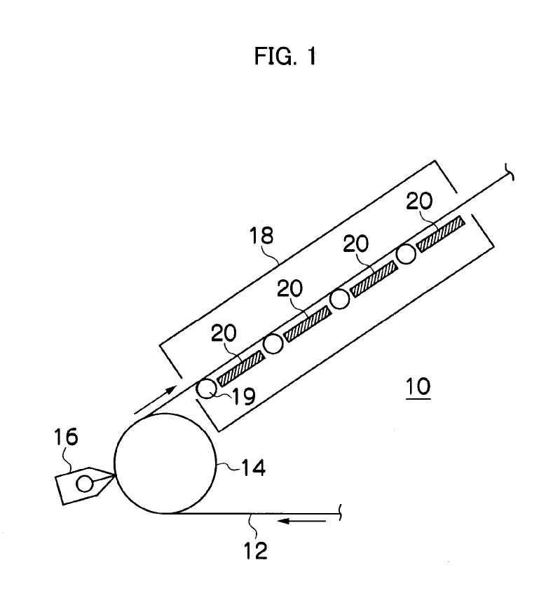

FIG. 1 is a conceptual diagram illustrating an example of a coating and drying line 10 incorporating a drying device to which a method and device for drying a coating film according to the present invention is applied.

As shown in FIG. 1, the coating and drying line 10 mainly includes a feeding device (not shown) which feeds a flexible film 12 wound in a roll shape, coating means 16 which coats the flexible film 12 wound around a back-up roller 14 with a coating solution, a drying device 18 which dries a coating film formed on the flexible film 12, a winding device (not shown) which winds a product produced by coating and drying, and a plurality of guide rollers 19 which form a conveyor path along which the flexible film 12 travels.

Resin films of polyethylene, PET (polyethylene terephthalate), and TAC (triacetate), papers, metal foils or the like may be used for the flexible film 12.

Various types of coating means may be employed as the coating means 16. For example, a slot die coater, a wire bar coater, a roll coater, a gravure coater, slide hopper coating means, and curtain coating means may be employed.

A dust removing device may be installed or a pretreatment or the like may be performed on the surface of the flexible film 12 on the upstream side of the coating means 16. As for an optical film or the like where high quality is required such that there is little dust, a dried coating film of high quality can be obtained by employing both the dust removing device and the pretreatment on the surface.

In the drying device 18, a plurality of infrared radiation plates 20 (infrared radiators) which radiate infrared rays to the flexible film 12 are provided inside a device body for drying the coating film immediately after coating by feeding and discharging hot air.

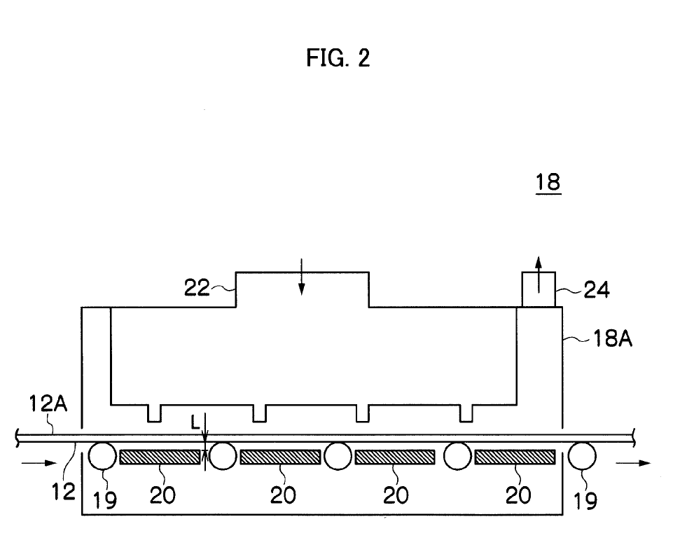

FIG. 2 is a sectional schematic view for explaining the configuration of the drying device 18 in further detail. FIG. 2 shows a case where a coating film 12A is formed on the upper side in the vertical direction.

As shown in FIG. 2, the drying device 18 includes an air feed duct 22 which feeds hot air to the coating film surface, and an air discharge duct 24 which discharges the hot air used for drying the coating film in a drying device body 18A. The plurality of infrared radiation plates 20 are provided on the non-coating film surface side of the flexible film 12 at a predetermined distance therefrom.

The air feed duct 22 is arranged on the upstream side in the traveling direction of the flexible film 12, so as to blow the hot air onto the coating film surface. The air discharge duct 24 is arranged on the downstream side in the traveling direction of the flexible film 12 from the air feed duct 22, so as to discharge a solvent or the like evaporated from the coating film.

The infrared radiation plate 20 is a plate-like member, and is disposed facing the non-coating film surface of the flexible film 12 at a given distance L from the non-coating film surface. The infrared radiation plate 20 is heated by the hot air inside the drying device body 18A to radiate infrared rays, thereby heating the flexible film 12 by radiation heat.

The infrared rays have a wavelength range of about 0.76 μm to 1 mm, and are divided into a near-infrared range (0.76 to 2 μm), a mid-infrared range (2 to 4 μm), and a far-infrared range (4 μm to 1 mm). As the wavelength range is shorter, the heating efficiency is improved. The far-infrared range is preferable in that the far-infrared range has excellent absorbability into the resin or the like of the coating film surface.

Although the material of the infrared radiation plate 20 is not particularly limited, a material having a thermal conductivity of 10 W/(m·K) or more is preferably employed in view of easiness of introducing the heat of the hot air. Particularly, metal such as stainless steel having excellent corrosion resistance is preferably used. As another material, ceramics or the like may also be employed, and alumina or zirconium fine ceramics are particularly preferable.

The infrared radiator is not limited to the plate-like member such as the above infrared radiation plate 20 as long as the infrared radiator can uniformly heat the entire plane of the flexible film 12. For example, a pipe-like member may also be employed. To improve the efficiency of infrared radiation, the surface of the infrared radiator is preferably coated with a material radiating a large amount of infrared rays. The infrared radiator may be coated with ceramics as the material radiating a large amount of infrared rays. Alternatively, the infrared radiator may be made to act as a black body (a black body treatment) by applying a black body coating, or adhering a black body tape to coat the infrared radiator with black color. The black body means a material having a high emissivity in the infrared range, and the emissivity is preferably 80% or more, more preferably 90% or more, and still more preferably 95% or more in a wavelength range of 5 to 15 μm, for example. Also, the black body treatment means a treatment for imparting a property close to that of the black body, and does not necessarily means that the surface is black in the visual light range. The infrared radiator may have such a surface shape as to increase the surface area of the plate member or the pipe member, or may be processed in such a manner as to increase the surface area thereof. Particularly, a metal plate whose surface is coated with black color is preferable as the infrared radiation plate 20. The wavelength and radiation efficiency of the infrared rays from the infrared radiator can be adjusted by the material of the infrared radiator, the type of the surface coating, the heating temperature or the like.

The infrared radiator is not limited to the plate-like member and the pipe-like member described above. A general infrared heater which radiates infrared rays such as a panel electric infrared heater and a far-infrared heater may also be employed.

To improve the heating efficiency of the radiation heat, the distance L between the infrared radiation plate 20 and the flexible film 12 is preferably 100 mm or less, more preferably 50 mm or less, and still more preferably 10 mm or less. To uniformly heat the entire coating film surface, the infrared radiation plate 20 preferably has a width equal to or larger than the width of the coating film.

Next, the operation of the coating and drying line 10 in FIG. 1 will be described.

The flexible film 12 is fed by the unillustrated feeding device, and conveyed to the coating means 16. Dust on the surface of the flexible film 12 may be removed by the unillustrated dust removing device if necessary.

Subsequently, the flexible film 12 is coated with the coating solution by the coating means 16, and the coating film is dried on the drying device 18. The wet thickness of the coating film may be 25 μm or less.

In the drying device 18, the hot air is blown out from the coating film surface side to dry the coating film, and the coating film is also heated from the non-coating surface side of the flexible film 12 by the radiation heat from the infrared radiation plate 20. That is, the infrared radiation plate 20 is heated with the hot air to radiate the infrared rays, thereby heating the coating film. For example, when an optically anisotropic layer of an optical compensation sheet is dried and heated with hot air having a temperature of 130° C. at a wind speed of 5 m/sec or less, the temperature of the infrared radiation plate 20 is preferably equal to or lower than the temperature of the hot air, and more specifically, 80 to 130° C.

When the wind speed of the hot air is too large, the coating film surface in a fluid state may become uneven when blown particularly in the initial drying stage. Thus, the wind speed is preferably set to 0.5 m/sec or less.

By employing both the hot air drying and the low temperature heating using the infrared rays as described above, delayed drying and insufficient heating due to insufficient temperature rise of the coating film surface in the initial drying stage after coating can be resolved, and the temperature rise time of the coating film can be reduced. Accordingly, a theoretical effective process length can be extended without extending the process length on the line, so that the production efficiency can be substantially improved.

Also, since both the hot air drying and the heating using the infrared rays are employed, it is not necessary to raise the heating temperature of the infrared rays higher than the temperature of the hot air. Thus, energy consumption required for drying can be reduced, and the drying efficiency can be substantially improved.

Also, the radiation heat of the infrared rays does not have a higher temperature than the hot air temperature since the infrared rays employ the hot air as a heat source. Thus, the coating film can be heated at a low temperature equal to or lower than the hot air temperature without performing temperature control, and a reduction in quality due to the increased temperature of the coating film can be prevented. Since the infrared radiation plate 20 is arranged on the non-coating film surface side, foreign substances do not possibly fall onto and adhere to the coating film surface from the infrared radiation plate 20.

Furthermore, even when the production line is stopped due to a mechanical failure or the like during a continuous production process, it is possible to prevent the flexible film from being rapidly heated to be reduced in quality as in the case of a high-temperature heater since the heating temperature of the infrared rays is equal to or lower than the hot air temperature.

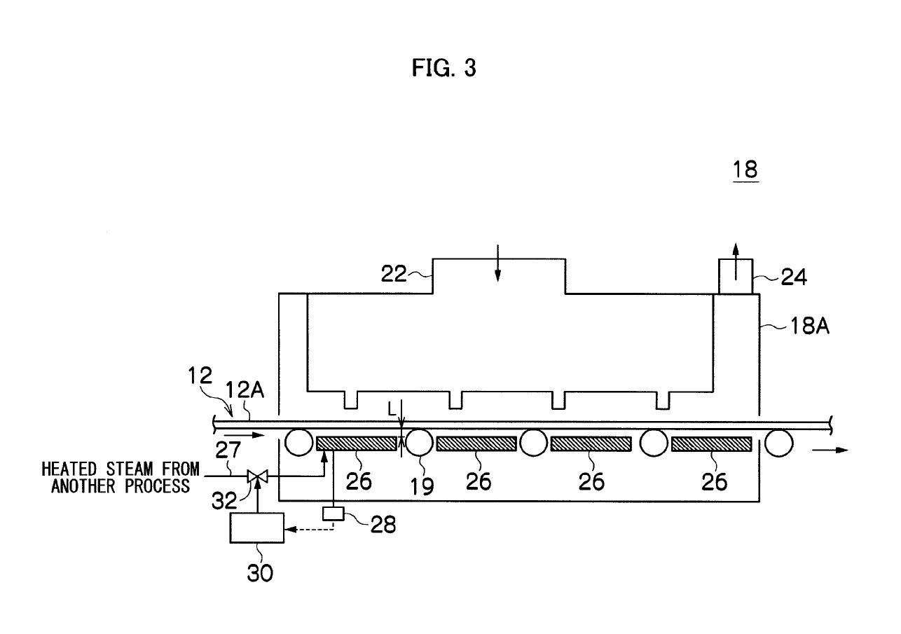

Although the present embodiment is described based on the example in which the infrared radiation plate 20 is installed as the infrared radiator which heats the coating film at a low temperature equal to or lower than the hot air temperature, the present invention is not limited thereto. For example, the configuration as shown in FIG. 3 may be employed in a case where the heating temperature of the infrared radiator needs to be adjusted.

FIG. 3 is an explanatory view for explaining another embodiment of the drying device 18.

As shown in FIG. 3, the configuration is almost the same as that in FIG. 2 except that the infrared radiation plates 20 are removed, and a pipe-like infrared radiator 26, a thermometer 28 which measures the heating temperature of the pipe-like infrared radiator 26, and control means 30 which controls the pipe-like infrared radiator 26 to a predetermined heating temperature are provided.

For example, an infrared radiator formed into a panel shape by meandering a single hollow pipe is used as the pipe-like infrared radiator 26. The pipe-like infrared radiator 26 communicates with a pipe 27 having a valve 32, and an exhaust heat source (hot air, superheated steam, hot water, steam or the like) is supplied through the pipe 27 from another process.

A measurement result from the thermometer 28 is input to the control means 30. The control means 30 controls the opening degree of the valve 32 based on the measurement result, to adjust the amount of exhaust heat source supplied to the pipe-like infrared radiator 26. Accordingly, the pipe-like infrared radiator 26 can be adjusted to a predetermined heating temperature, that is, the hot air temperature or lower.

By employing the configuration described above, both the hot air drying and the heating using the infrared rays are employed to dry and heat the coating film, so that the drying and heating efficiency can be substantially improved.

Also, the heating temperature of the infrared rays can be adjusted. Thus, the heating temperature can be maintained at such a level as not to reduce the quality of the coating film.

As described above, when the drying method and device according to the present invention are employed, the temperature rise time of the coating film in the initial drying stage after coating can be reduced. Accordingly, the theoretical effective process length can be extended without extending the process length on the line, so that the production efficiency can be substantially improved. Also, it is not necessary to raise the heating temperature of the infrared rays higher than the hot air temperature. Thus, the energy consumption required for drying can be reduced, and the drying efficiency can be substantially improved without reducing the quality.

Although the aforementioned respective embodiments are described based on the example where the coating film is dried and heated in an upward state in the vertical direction, the present invention is not limited thereto. The coating film may be dried and heated in a downward state in the vertical direction. Also, the example where the infrared radiator is installed on the surface side where the coating film is not formed (the non-coating surface side of the flexible film) is described. However, the present invention is not limited thereto, and the infrared radiator may be disposed facing the coating film surface side. In this case, hot air feed port and discharge port, the infrared radiator or the like are preferably disposed such that the hot air uniformly flows near the coating film between the infrared radiator and the coating film surface, for example.

Although the example where the drying device and method according to the present invention are mainly applied to the initial drying stage of the coating film is described in the aforementioned respective embodiments, the present invention is not limited thereto. The drying device and method according to the present invention may also be applied to various heating processes (heat treatment processes) after the initial drying of the coating film.

In the above embodiment shown in FIG. 3, the exhaust heat source may be heat-exchanged with a cooling medium or the like, and then supplied to the pipe-like infrared radiator 26. The temperature of the pipe-like infrared radiator 26 can be thereby further freely adjusted.

The present invention can be widely applied to the drying and heating process of the coating film. For example, the present invention is preferably applied to the production of optical films such as optical compensation sheets, antireflection films, antidazzle films, and polarizing plates. The present invention may also be applied to a production technique such as a process of drying or heating various cell electrode materials, magnetic materials, and photosensitive materials, for example.

### EXAMPLE

In the following, further features of the present invention will be specifically described by reference to an example. Note that the specific example described below should not limit the scope of the present invention.

### Example 1

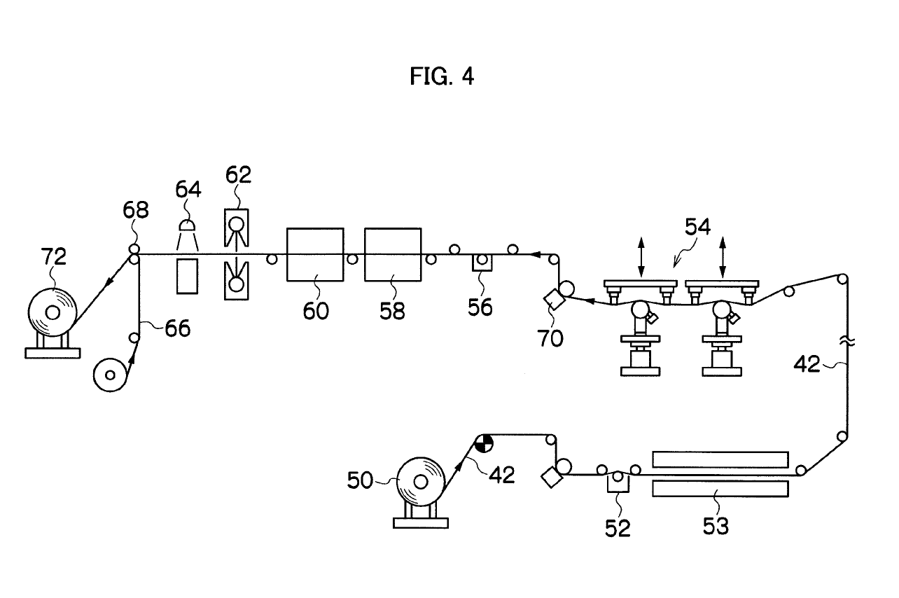

As shown in FIG. 4, in the production line of an optical compensation sheet, the following processes are performed, for example. In FIG. 4, the coating surface is downward in the vertical direction in an alignment film forming process, and is also downward in processes after rubbing treatment.

(1) a process 50 of feeding a transparent film 42;

(2) a process 52 of forming an alignment film-forming resin layer, wherein a coating solution containing an alignment film-forming resin is coated and dried on the surface of the transparent film 42;

(3) a rubbing process 54 of performing rubbing on the surface of the alignment film-forming resin layer to form an alignment film on the transparent film 42 with the alignment film-forming resin layer formed on the surface;

(4) a process 56 of coating a liquid crystalline discotic compound, wherein a coating solution containing the liquid crystalline discotic compound is coated on the alignment film;

(5) a drying process 58 of drying the coating film to evaporate a solvent in the coating film (the drying device according to the present invention);

(6) a process 60 of forming a liquid crystal layer, wherein a liquid crystal layer of a discotic nematic phase is formed by heating the coating film to a temperature of forming a discotic nematic phase;

(7) a process 72 of solidifying the liquid crystal layer (that is, solidifying the liquid crystal layer by rapid cooling after the liquid crystal layer is formed, or cross-linking the liquid crystal layer by light irradiation (or heating) when a liquid crystalline discotic compound containing a cross-linkable functional group is used); and

(8) a process 64 of winding the transparent film 42 where the alignment film and the liquid crystal layer are formed.

In FIG. 4, the drying method and device according to the present invention are applied to the drying process 58. Reference numeral 53 designates a drying zone, 64 an inspection device, 66 a protective film, 68 a laminating machine, and 70 a dust removing device, respectively.

The optical compensation sheet was produced by continuously performing the processes from the process of feeding a long transparent film to the process of winding the obtained optical compensation sheet as shown in FIG. 4. A 5 wt. % long chain alkyl-modified poval (MP-203, manufactured by Kuraray Co., Ltd.) solution was coated on one side of the long transparent film 42 of triacetyl cellulose (Fujitac, manufactured by Fuji Photo Film Co., Ltd., thickness: 100 μm, width: 500 mm), and dried at a temperature of 90° C. for 4 minutes, to form an alignment film-forming resin layer having a film thickness of 2.0 μm. An alignment film was formed by rubbing the surface of the alignment film-forming resin layer, and dust was removed therefrom. The rubbing treatment was performed at a rotation speed of a rubbing roller of 300 rpm.

The triacetyl cellulose film satisfied a relationship of (nx−ny)×d=16 nm, {(nx−ny)/2−nz}×d=75 nm wherein nx and ny represented the refractive indexes in two perpendicular directions within the film plane, nz represented the refractive index in the thickness direction, and d represented the thickness of the film.

Subsequently, a 10 wt % methyl ethyl ketone solution (a coating solution) of a mixture obtained by adding 1 wt. % of a photoinitiator (Irgacure 907, manufactured by Nihon Ciba-Geigy K.K.) to a mixture of a discotic compound TE-8 (3) and a discotic compound TE-8 (5) mixed at a weight ratio of 4:1 was coated on the obtained alignment film in a coating amount of 5 cc/m² by a wire bar coater.

Subsequently, the film passed through the drying and heating zones. Air of 5 m/sec was fed into the drying zone, and the heating zone was adjusted to 120° C. The film entered the drying zone 3 seconds after coating, and entered the heating zone 3 seconds thereafter. The film passed through the heating zone in about 3 minutes.

An ultraviolet lamp emitted ultraviolet rays to the surface of the liquid crystal layer of the transparent film 42 coated with the alignment film and the liquid crystal layer. To be more specific, the transparent film 42 passing through the heating zone was irradiated with ultraviolet rays having an illuminance of 600 mW from an ultraviolet emission device (an ultraviolet lamp: output: 160 W/cm, emission wavelength: 1.6 m) for 4 seconds, to cross-link the liquid crystal layer. The conveying speed of the transparent film 42 was 40 m/min.

Experiments were performed on the effect of installing the infrared radiation plate 20, and the influence of the conditions such as the temperature of the infrared radiation plate 20 and the distance between the infrared radiation plate 20 and the transparent film 42 on the temperature rise speed and quality of the coating film surface in the aforementioned drying and heating processes. In the following, the conditions and results are described.

### Experiment 1

The infrared radiation plate 20 was installed at a position apart from the transparent film 42 by 10 mm. The temperature of the infrared radiation plate 20 was the same as the hot air temperature, i.e., 120° C. The time length required for the coating film to reach the same temperature as the hot air temperature from a room temperature after entering the drying zone was obtained as the temperature rise time (second). The optical characteristics of the coating film after drying were evaluated on the following basis using the following retardation values.

A retardation value (Rth) is a value defined by the following expression (1), and a Re retardation value (Re) is a value defined by the following expression (2).

Rth={(nx+ny)/2−nz}×d Expression (1)

Re=(nx−ny)×d Expression (2)

[In the expressions (1) and (2), nx represents the refractive index in the slow axis direction in the film plane, ny the refractive index in the fast axis direction in the film plane, nz the refractive index in the thickness direction of the film, and d the thickness of the film.]

A: Rth satisfies a target value (range)

C: Rth is higher or lower than a target value (range)

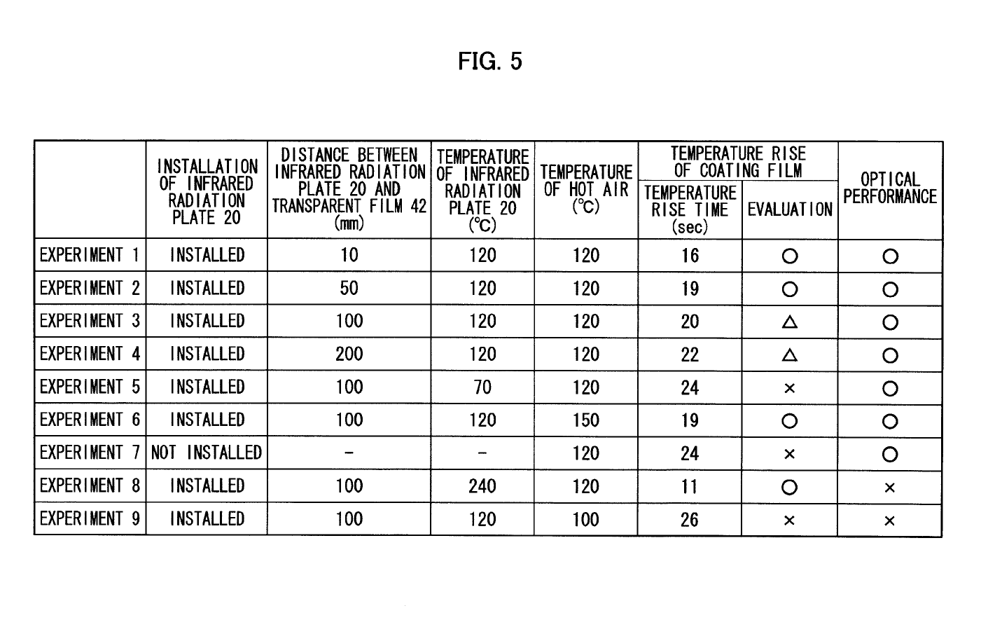

The results are shown in Table in FIG. 5.

### Experiment 2

Experiment 2 was performed in the same manner as Experiment 1 except that the infrared radiation plate 20 was installed at a position away from the transparent film 42 by 50 mm. The results are shown in Table in FIG. 5.

### Experiment 3

Experiment 3 was performed in the same manner as Experiment 1 except that the infrared radiation plate 20 was installed at a position away from the transparent film 42 by 100 mm. The results are shown in Table in FIG. 5.

### Experiment 4

Experiment 4 was performed in the same manner as Experiment 1 except that the infrared radiation plate 20 was installed at a position away from the transparent film 42 by 200 mm. The results are shown in Table in FIG. 5.

### Experiment 5

Experiment 5 was performed in the same manner as Experiment 3 except that the temperature of the infrared radiation plate 20 was 70° C. The results are shown in Table in FIG. 5.

### Experiment 6

Experiment 6 was performed in the same manner as Experiment 3 except that the temperature of the infrared radiation plate 20 was 120° C. and the hot air temperature was 150° C. The results are shown in Table in FIG. 5.

### Experiment 7

Experiment 7 was performed in the same manner as Experiment 1 except that the infrared radiation plate 20 was not installed. The results are shown in Table in FIG. 5.

### Experiment 8

Experiment 8 was performed in the same manner as Experiment 3 except that the temperature of the infrared radiation plate 20 was 240° C. The results are shown in Table in FIG. 5.

### Experiment 9

Experiment 9 was performed in the same manner as Experiment 3 except that the temperature of the infrared radiation plate 20 was 120° C. and the hot air temperature was 100° C. The results are shown in Table in FIG. 5.

As shown in Table in FIG. 5, in Experiments 1 to 6, the infrared radiation plate 20 having a temperature equal to or lower than the hot air temperature was installed, and in Experiment 7, the infrared radiation plate 20 was not installed. In Experiments 8 and 9, the infrared radiation plate 20 having a temperature higher than the hot air temperature was installed.

In Experiments 1 to 6, it has been found that the temperature of the coating film can be raised in a shorter time than in Experiment 7. It has been also found that, in Experiment 8, although the temperature of the coating film can be raised in a short time, Rth exceeds the target range since the temperature of the infrared radiation plate 20 is high, and in Experiment 9, Rth is reduced since the hot air temperature is low.

Experiments 1 to 6 show that the temperature rise time of the coating film is increased as the distance between the infrared radiation plate 20 and the transparent film 42 is extended. The reason is considered that the radiation heat is difficult to reach the coating film when the distance between the infrared radiation plate 20 and the coating film is extended. Thus, it has been found that the distance between the infrared radiation plate 20 and the flexible film 12 is preferably 100 mm or less.

Experiments 3 and 5 to 6 show that the heating effect is reduced when the temperature of the infrared radiation plate 20 is much lower than the hot air temperature. Thus, it has been found that the infrared radiation plate 20 is preferably set to the same temperature as the hot air temperature, or a temperature lower than the hot air temperature by about 30° C.

Next, the temperature rise speed depending on whether or not the infrared radiation plate 20 was installed, and the influence thereof on the effective process length in the drying process were examined by changing the conveying speed of the transparent film 42.

### Experiment 10

The infrared radiation plate 20 was installed at a position apart from the transparent film 42 by 10 mm. The temperature of the infrared radiation plate 20 was the same as the hot air temperature, i.e., 120° C. The temperature rise time (second) was measured when the conveying speed of the transparent film 42 was 20 m/min. The measured temperature rise time was compared with the temperature rise time (second) obtained when the infrared radiation plate 20 was not installed. The effective drying process length practically extended by installing the infrared radiation plate 20 was also calculated by the following expression, and evaluated on the following basis.

Effective drying process length=effect time (a time difference between the cases of installing and not installing the infrared radiation plate 20)×residence zone length in the time

For example, in Experiment 10, the effective drying process length is (12−8)/60×20=1(m).

A: the extended effective drying process length is 4 m or longer

B: the extended effective drying process length is longer than 0 m and shorter than 4 m

C: the effective drying process length is not extended (same as the case where the infrared radiation plate 20 is not installed)

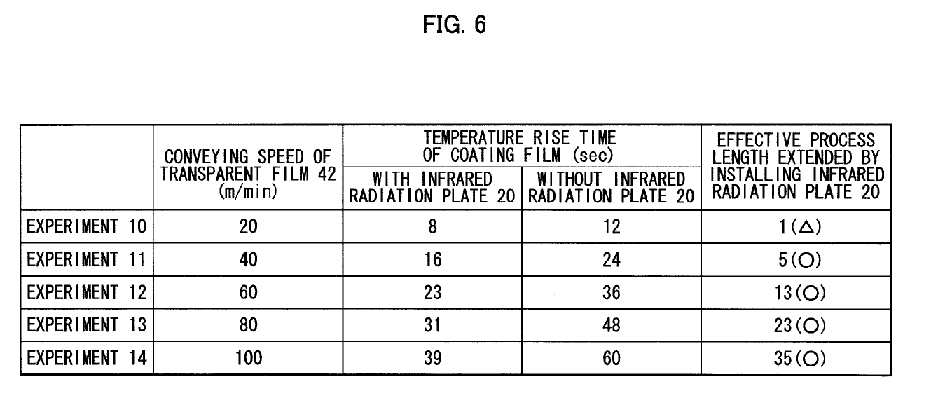

The results are shown in Table in FIG. 6.

### Experiment 11

Experiment 11 was performed in the same manner as Experiment 10 except that the conveying speed of the transparent film 42 was 40 m/min. The results are shown in Table in FIG. 6.

### Experiment 12

Experiment 12 was performed in the same manner as Experiment 10 except that the conveying speed of the transparent film 42 was 60 m/min. The results are shown in Table in FIG. 6.

### Experiment 13

Experiment 13 was performed in the same manner as Experiment 10 except that the conveying speed of the transparent film 42 was 80 m/min. The results are shown in Table in FIG. 6.

### Experiment 14

Experiment 14 was performed in the same manner as Experiment 10 except that the conveying speed of the transparent film 42 was 100 m/min. The results are shown in Table in FIG. 6.

Table in FIG. 6 shows that as the conveying speed of the transparent film 42 is larger, the temperature of the coating film rises faster by installing the infrared radiation plate 20. It has also been found that such an effect that the transparent film 42 is heated longer by the effective process length can be obtained by installing the infrared radiation plate 20 in comparison with the case where the infrared radiation plate 20 was not installed.

Thus, it has been found that desired drying and heating can be performed and the production efficiency can be thereby substantially improved even when the conveying speed of the transparent film 42 is increased.

1. A drying device which dries a coating film formed on a substrate with hot air, comprising:
an infrared radiator which heats the coating film at a temperature equal to or lower than a temperature of the hot air.

2. The drying device according to claim 1, wherein the infrared radiator is a plate member or a pipe member which is disposed facing the substrate at a predetermined distance from the substrate.

3. The drying device according to claim 2, wherein a distance between the infrared radiator and the substrate is 100 mm or less.

4. The drying device according to claim 1, wherein a surface of the infrared radiator is coated with ceramics or black color.

5. The drying device according to claim 1, wherein the infrared radiator is made of metal.

6. The drying device according to claim 1, wherein the infrared radiator is heated by one or more of hot air, steam, superheated steam, and hot water generated in the hot air drying process or another process.

7. A method for producing an optical film, comprising the steps of coating a travelling long substrate with a coating solution for optical applications, and drying the coating solution with hot air,
wherein the coating solution is dried by using a device according to claim 1.

8. The method for producing an optical film according to claim 7, wherein a heating temperature of the infrared radiator is 80 to 150° C.

9. The method for producing an optical film according to claim 7, wherein the coating solution contains a liquid crystalline compound.
